(19) United States
(12) Patent Application Publication
(10) Pub. No.: US 2012/0137903 A1
(43) Pub. Date: Jun. 7, 2012

(54) ENERGY SAVING IN HYDRAULIC BENDING PRESSES

(75) Inventor: Suat Demirer, Ankara (TR)

(73) Assignee: DEMIRER TEKNOLOJIK SISTEMLER SANAYI TICARET LIMITED SIRKETI, Ankara (TR)

(21) Appl. No.: 13/390,611

(22) PCT Filed: May 12, 2010
(86) PCT No.: PCT/TR10/00091

§ 371 Date: Feb. 15, 2012

(30) Foreign Application Priority Data
Aug. 18, 2009 (TR) 2009/06352

(51) Int. Cl. B30B 15/18; B21D 11/20; B30B 1/32

(52) U.S. Cl. 100/269.16; 100/269.14; 72/373

(57) ABSTRACT

Bending presses containing pistons providing up and down motion of the upper clamp, at least one engine for motion of the said pistons, and filling valves providing pre-filling during quick down and up motion of the pistons. The bending presses contain at least one pump of variable rotation and fixed displacement transmitting the motion received from the said engine to the pistons.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The invention relates to an embodiment allowing operation at bending press machines providing bending and shaping the work materials by applying press on sheet materials of metal type by means of conduct of metal bending at less energy consumption, less oil use, more accurate down-up motions and less sound level.

The said invention relates to bending press integrated with at least one pump transmitting the driving received from the engine to pistons with variable recycling, fixed displacement, at least one pilot command system accumulating the energy generated during pressing to the places requiring pressure such as the said filling valves, safety valves.

2. Description of Related Art

Including Information Disclosed Under 37 CFR 1.97 and 37 CFR 1.98.

In the system commonly applied in the related art, the electrical engine constantly rotates to supply oil to the system regardless of performance of work. This operation causes energy consumption and non-required oil heating even when machine does not perform work. In addition, proportional direction control valves used to maintain the parallel position during up and down motions of the bending form (matrix), speed adjustment valves, and other valves for quick and slow motions are used and they operate by controlling through an electronic circuit. These valves of several number used in the system cause pressure loss at several points. Because these valves are frequently turned down for accuracy of the motion (that is parallel position). During turning down operation both sound level increases and big amount of pressure loss occurs. The oil in the system heats because of pressure losses and the viscosity of the oil changes when the oil heats, and the setting made on the electronic card starts to fail to respond accurately as required. In other words, it gets difficult to maintain parallel position because of change in feature of oil. Moreover, coolers and a large amount of oil is used to balance the heat increase in the systems as required. And this causes oil waste.

When searching patents related to bending presses, some patent applications were seen. Among them is patent application numbered EP02791546 filed by WILSON TOOL INTERNATIONAL, INC. on 2002 Jul. 26. The Abstract part of the invention reads as “the invention is a holder intended for mounting to bending press form containing a mounting support and it is characterized in that it consists of a body having support plate of the holder press and a clamp having upper and lower part and connected between lower and upper parts of the body in rotating position and a liquid inlet point allowing compressing the mounting support of the form between lower part and support plate of the clamp, a hole to provide compressed liquid to a place in the hole, a spindle containing a longitudinal eccentric surface allowing sliding in the hole in respect to providing liquid under pressure into the hole, a primary region of a bigger thread diameter in comparison to a secondary outer small diameter region of eccentric surface, motion of body against axial movement of the spindle in order to force the clamp to rotate in respect to the body and containing a pushing roller capable to connect to eccentric surface and thus driving the lower part of the clamp to support plate or a distance farther than it and compressing or opening of the mounting support of the form.

Another application is the patent application numbered EP 1741501 and dated on 2006 Jul. 5. The abstract part of the invention reads as “the invention relates to security device for a production unit for bending a sheet metal component, in particular for a bending press, with a stationary table beam and with a press beam which can be moved linearly relative to the table beam in a guide system by means of a drive mechanism, and with bending tools disposed in tool holders on oppositely lying end faces of the table beam and press beam forming an operating region between mutually facing forming regions, and with a light beam emitter and receiver system monitoring the operating region for ingress by a foreign body, where the bending tool disposed in the press beam is provided in the form of a lamella packet comprising at least one reference lamella and at least one tool lamella which can be displaced relative to it, which tool lamella is provided with cut-outs extending through it in the direction of a thickness which when aligned, form a beam passage for a light beam, in particular a laser beam, extending parallel with the end face of the press beam.

### BRIEF SUMMARY OF THE INVENTION

Differently from the existing related art, the purpose of the invention is that it contains technical features different from the bending press in the related art and provides a new solution. For instance, the engine only operates while performing work and thus energy consumption is prevented when not required.

One purpose of the invention is to provide motions of the bending form (matrix) for bending operation of the press in hydraulic system by work members such as pump, engine, valve and cylinder. Some of those members are eliminated and some are amended and thus pressing, that is metal bending operation is conducted by use of less energy, less oil, more accurate down up motions and less sound level.

Another purpose of the invention is to allow operation without the need for work members such as direction control valves, flow adjustment valves, and pressure adjustment valves. Thus pressure losses are minimized to a level nearly none, the heating of oil is prevented and thus amount of oil is decreased, sound level is reduced and also energy loss is minimized. For instance, savings up to 60% has been provided.

A further purpose of the invention is to change the pump type used widely in the systems and to use a pump capable to rotate in both directions (variable recycling), to provide driving by control of engine rotation of the pump with hydraulic position control, and thus allow adjustment of pressure even in a static position.

Another purpose of the invention is to perform the duties of valves by help of feature of pump ending in no need for valves for position setting. Up or down movement of the work member (cylinder) in the system is provided by right or left rotation of the pump instead of direction control valve. Valves such as flow control valves and pressure setting valves are not needed by help of speed control of the engine.

A further purpose of the invention is to decrease the amount of oil used in the system since there is no need for flow control and pressure setting valves and therefore elimination of viscosity change of the oil by conversion of energy into heat during turning down operations when such valves are used. Furthermore, the new system used in the pump generates additional energy by re-gaining energy generated during down motion of the press by use of weight of the bending form (matrix).

A different purpose of the invention is to eliminate the need for electronic card adjustment for each valve arising from sliding embodiments in the valves as the hydraulic proportional valves are eliminated. And this eliminates the time loss arising from separate adjustments during serial manufacturing and thus provides contribution in increase of production. Since the system consists of simple members, the service costs are also kept at minimum.

In order to achieve the above mentioned purposes, it contains at least one pump transmitting the driving received from the engine to pistons with variable recycling, fixed displacement, at least one pilot command system accumulating the energy generated during pressing to the places requiring pressure such as the said filling valves, safety valves.

### BRIEF DESCRIPTION OF THE DRAWINGS

In order to make the embodiment and additional members being subject of the present invention as well as the advantages clearer for better understanding, it should be assessed with reference to the fallowing described figures.

FIG. 1 is a perspective view of new hydraulic system together machine integrated with bending press machine being subject of the invention.

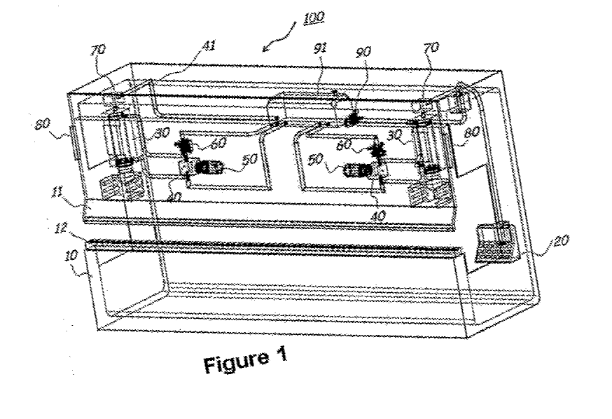

FIG. 2 is a two dimension schematic view indicating the hydraulic system being the subject of the invention.

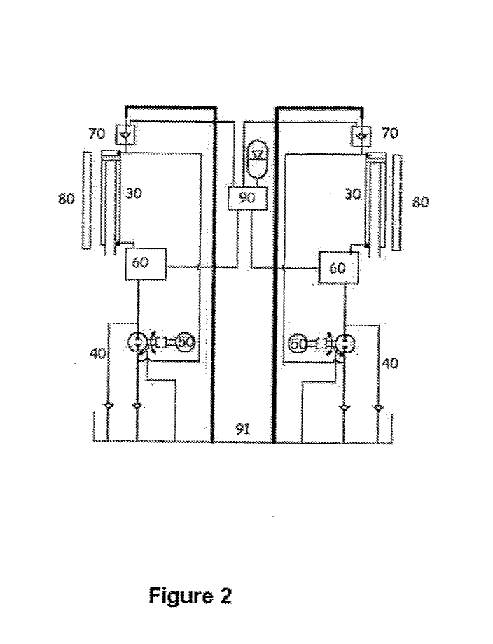

### REFERENCE NUMBERS

10. Machine body

11. Upper clamp

12. Lower clamp

20. Command unit

30. Pistons

40. Pumps

41. Pipes

50. Engines

60. Safety valves

70. Filling valves

80. Position ruler

90. Pilot command valve block

91. Oil tank

100. Bending press

### DETAILED DESCRIPTION OF THE INVENTION

In this detailed description, the preferred embodiments of the bending press machine (100) being subject of this invention have been disclosed solely for the purpose of better understanding of the subject and described in a manner not causing any restrictive effect.

In respect to components of existing state of art, the invention contains pistons (30) providing up and down motion of the upper clamp (11), at least one engine (50) for motion of the said pistons (30), valves (70) providing pre-filling during quick down and up motion of the pistons (30).

In respect to the inventive components of the said invention, it contains at least one pump (40) transmitting the driving received from the said engine (50) to pistons (30) with variable recycling, fixed displacement, at least one pilot command block (90) accumulating the energy generated during pressing and transmitting to the places requiring pressure such as the said filling valves (70), safety valves (60).

For start of motion of the pistons (30) adapted to the machine body (10), the pre-filling valves (70) are opened and the downward motion of the pumps (40) driven by the engines (50) is started. Without damaging parallel position by use of signals fed from the rulers (80), downward motion continues. The energy generated due to weight of the mass during going down is converted into electric generation. This process continues at high speed until the bending form (matrix) arrives the material to be bended and generates energy. Slowing down is made at a safe distance, the operations are realized by the signals received from the position rulers (80) and the speed command of the engine (50).

Here the filling valves (70) are closed and pressing operation is started. Engine (50) speed is progressed at the revolving foreseen for pressing and the pressing operation is completed by the position data received from the rulers (80). The filling valves (70) are opened and upon opposite rotation of the engines (50) the upward motion of the pistons (30) is started. When the distance required for bending is taken, the filling valves (70) are closed and waiting position is started. Then the operation to be carried out will be re-started according to request of the user. All of those operations are carried out only by pump (40) and right or left motions of the engines (50) without use of any direction control valve. These operations are carried out without use of valve other than the valve to perform locking for prevention of falling of the bending form (matrix) in case of cut of power required for filling valves (70) and CE.

Bending press (100) is C type press in terms of structure. The main body is formed by means of adding a vertical plate of 90 degrees angle to the two parallel C edges and this plate also performs the duty of carrying form body. The 2 cylinders perpendicular to the plate of the main body provides motion of the bending form (matrix) on a vertical block Y axis where it will be connected.

Some members in this system are changed and the press can be operated in the same logic. For that reason, it is possible to obtain more different embodiments by change of valve. For instance, pilot command valve block (90) can be operated by means of installing an electrical commanded valve instead of check valve.

In order to perform bending operation at bending press (100), a lower clamp (12) is located under the upper clamp (12). The system contains a command unit (20) for commanding it. It also contains an oil tank (91) to supply oil the hydraulic system and pipes (41) for distributing the oil to the valves (60-70) and pistons (30).

Process steps of the hydraulic system integrated to bending press (100) consists of:

opening of the filling valves (60) upon start instruction given to the system,

rotation of pumps (40) to descending direction upon driving of the pumps (40) by engines (50), and downward movement of the bending form (matrix) (upper clamp (11),

closing of the filling valves (70) before slowing down of the bending form (matrix) at desired position at the ruler (80) and start of pressing operation,

conduct of accurate bending operation by the bending form (matrix) with the data to be sent to the engine (50) according to the position data received from the ruler (80),

after bending operation, while the engine (50) and pump (40) rotate in reverse direction, opening of filling valves (70) and movement of the bending form (matrix) to the desired position by the pistons (30), and

when the bending form (matrix) reaches its position, keeping all components at ready position without consuming any power.

The protection area of this application has been specified under claims and cannot be limited to the descriptions only given as sampling above. It is clear that any innovation can be provided by a person skilled in the related art by use of the similar embodiments and/or can also apply this embodiment in other areas for similar purposes used in the related art. Therefore, such embodiments will be lack of novelty and inventive step criteria.

1. The invention relates to bending presses containing pistons providing up and down motion of the upper clamp, at least one engine for motion of the said pistons, valves providing pre-filling during quick down and up motion of the pistons and it comprises at least one pump of variable rotation, fixed displacement transmitting the motion received from the said engine to the pistons.

2. A bending press according to claim 1 and it contains at least one Pilot Command Valve Block accumulating the energy generated during pressing and transmitting it to the places requiring pressure such as the said filling valves, and safety valves.

3. A bending press according to claim 2 wherein an electrical commanding valve is used instead of the said Pilot Command valve Block.

4. The invention is a method relating to bending presses containing pistons providing up and down motion of the upper clamp, at least one engine for motion of the said pistons, valves providing pre-filling during quick down and up motion of the pistons wherein upon driving of the pumps by engines, the pumps rotate in descending direction and upper clamp is moved downward.

5. A method according to claim 4 wherein accurate bending operation is conducted by the bending form (matrix) with the data to be sent to the engine according to the position data received from the ruler.

6. A method according to claim 5 wherein after bending operation, while the engine and pump rotate in reverse direction, pre-filling valves are opened and the bending form (matrix) is moved up to the desired position by the pistons.

7. A method according to claim 6 wherein when the bending form (matrix) reaches its position, all components are kept at ready position without consuming any power.
